(19) United States
(12) Patent Application Publication
(10) Pub. No.: US 2025/0295231 A1
(43) Pub. Date: Sep. 25, 2025

(54) COMPUTER-ASSISTED METHOD FOR MOVING A MOVABLE FURNITURE PART, MICROCONTROLLER, AND COMPUTER PROGRAM PRODUCT

(71) Applicant: Julius Blum GmbH, Hoechst (AT)

(72) Inventors: Alexander PETERLUNGER, Lustenau (AT); Bjoern GASSER, Mellau (AT)

(21) Appl. No.: 19/228,184

(22) Filed: Jun. 4, 2025

Related U.S. Application Data
(63) Continuation of application No. PCT/AT2023/060420, filed on Dec. 1, 2023.

(30) Foreign Application Priority Data
Dec. 23, 2022 (AT) A 50994/2022

(51) Int. Cl. A47B 88/457; E05F 15/635

(52) U.S. Cl. CPC A47B 88/457; E05F 15/635; E05Y 2201/722; E05Y 2400/40; E05Y 2900/20

(57) ABSTRACT

A method for moving a movable furniture part relative to a stationary furniture part along a guiding mechanism by an electric drive device for automatically moving certain regions of the movable furniture part relative to the stationary furniture part via an electric motor, includes the following method steps preferably in chronological order: determining a model of the movable furniture part depending on a static dataset stored in a memory unit using a microcontroller including a computing unit and the memory unit that either is or can be connected to the computing unit in a data-transmitting manner; manually moving the movable furniture part either from an open position or a position between the open position and a closed position towards the closed position, and/or vice versa; and calculating a predicted movement trajectory of the movable furniture part along the guiding mechanism depending on at least one dynamic dataset using the microcontroller.

The present application is a continuation of International Application PCT/AT2023/060420 filed on Dec. 1, 2023. Thus, all of the subject matter of International Application PCT/AT2023/060420 is incorporated herein by reference.

### BACKGROUND OF THE INVENTION

The invention relates to a computer-assisted method for moving a movable furniture part, in particular a drawer, relative to a stationary furniture part, in particular a furniture carcass, along a guiding mechanism, in particular a drawer pull-out guide, by electric drive device, in particular one which can be supplied with 230 V, for automatically moving at least certain regions of the movable furniture part relative to the stationary furniture part via an electric motor. Furthermore, the invention relates to a microcontroller for carrying out such a method, an electric drive device for automatically moving at least regions of a movable furniture part relative to a stationary furniture part via an electric motor with at least one such microcontroller, an arrangement comprising such an electric drive device and a stationary furniture part, and a computer program product.

A method for moving a movable furniture part is already known from document EP 1 323 364 A1, in which a drawer is moved by means of a drive unit controlled by a release device. The release device comprises two manually operated push buttons—for example a drag switch—arranged on the drawer for three different switching states. The release device can be initiated depending on the relative position of furniture part components or by tapping a furniture part component to generate a switching pulse.

A method for moving a movable furniture part is also already known from document EP 1 323 363 A1, in which a drive unit is controlled by a control device and a force measuring device in order to automatically support a movement desired by the user of a drawer in a bidirectional manner. In addition, a position measuring device may be present which generates a position signal by means of which a current actual position, actual speed and actual acceleration can be calculated as a function of the measured position. Target values can also be determined so that essentially the same amount of force can be generated with varying drawer loads.

A method for moving a movable furniture part is also already known from document EP 2 642 899 A1, in which two sensors can generate different release sensitivities when force is exerted on a drawer.

A disadvantage of the prior art is that the existing control units for moving the movable furniture part—particularly due to the limited computing and storage capacities—can only provide rudimentary controls for a movement sequence of the movable furniture part. This results in undesirably disharmonious movement trajectories—particularly in the case of changing force applications and/or loads of the movable furniture part or in the case of varying guiding mechanisms—which can result in inappropriately high or low speeds of the movable furniture part, which do not allow movement into a desired end position of the movable furniture part and/or can cause damage.

### SUMMARY OF THE INVENTION

The object of the present invention is therefore to provide a method, as well as an electric drive device, an arrangement and a computer program product, in which the drawbacks of the prior art are at least partially eliminated, and which are characterized in particular by a an increased functionality.

It is therefore provided according to the invention that the following steps are carried out, in particular in chronological order:
a microcontroller comprising a computer and a memory unit that is or can be connected to the computer, determines a model of the movable furniture part depending on at least one static dataset stored in the memory unit
the movable furniture part is moved manually either from an open position or a position between the open position and a closed position towards the closed position, and/or vice versa
the microcontroller calculates a predicted movement trajectory of the movable furniture part along the guiding mechanism depending on at least one dynamic dataset

This makes it possible to generate assisted detection for a movement of the movable furniture part, wherein the movable furniture part can be driven in the closing direction or in the opening direction, for example, in such a way that the movable furniture part is moved into an end position (closed position or open position) substantially silently and/or without significant force being applied to the component parts. In general, a partial drive or a complete drive—in particular over the entire travel distance—into the end position is possible.

The movable furniture part can be subjected to force by the at least one electric drive device depending on the predicted movement trajectory, wherein the static dataset can be available depending on the movable furniture part as such (without underlying movement data of the movable furniture part such as speed), and the dynamic dataset can be available depending on the manual movement of the movable furniture part (for example, the actual speed of the movable furniture part). Thus, the microcontroller can calculate the predicted movement trajectory of the movable furniture part depending on the manual movement of the movable furniture part.

As stated at the outset, protection is also sought for a microcontroller for carrying out such a method, comprising a computer and a memory unit that is or can be connected to the computer for data transmission. The computer is configured to determine a model of a movable furniture part as a function of at least one static dataset stored in the memory unit and/or to calculate a predicted movement trajectory of the movable furniture part along a guiding mechanism as a function of a dynamic dataset stored in the memory unit.

As stated at the outset, protection is also sought for an electric drive device for automatically moving at least certain regions of a movable furniture part relative to a stationary furniture part via an electric motor with at least one such microcontroller.

As stated at the outset, protection is also sought for an arrangement comprising such an electric drive device and a stationary furniture part, in particular a furniture carcass, and the stationary furniture part comprises two furniture panels oriented vertically and parallel to one another in the use position of the arrangement. Exactly one electric drive device is arranged stationary on one of the two furniture panels, preferably indirectly via a carcass rail of a guiding mechanism, and at least one further release sensor is arranged stationary on the second furniture panel, preferably a carcass rail arranged on the second furniture panel, for activating the electric motor for a closed position of a movable furniture part arranged on the stationary furniture part. Preferably, the at least one further release sensor comprises a damping device and/or a buffer and/or is or can be brought into data connection with the electric drive device via a radio connection and/or a cable connection.

It is also possible for the arrangement to comprise an electric drive device without a corresponding microcontroller.

As stated at the outset, protection is also sought for a computer program product comprising commands which, when executed by a computer, cause the computer to carry out such a method as described above from a memory unit which is in a data connection with the computer or which can be brought into such a connection with the same.

Advantageous embodiments of the invention are defined in the dependent claims.

### BRIEF DESCRIPTION OF THE DRAWINGS

Further details and advantages of the present invention will be explained in more detail below with reference to the drawings, in which:

FIG. 1a, 1b show a guiding mechanism of a piece of furniture driven by an electric drive device according to a preferred embodiment in a perspective view with an enlarged detail in the area of the electric drive device,

FIG. 2-4 show the guiding mechanism according to the exemplary embodiment of FIG. 1b in perspective view with enlarged detailed representations in the area of a connection of a rack to a drawer rail,

FIG. 5 shows the guiding mechanism according to the exemplary embodiment of FIG. 1b in a view from above with an enlarged detail in the area of a coupling between the rack and a gear of the electric drive device,

FIG. 6 shows the guiding mechanism according to the exemplary embodiment of FIG. 1b in a view from below with an enlarged detail in the area of a connection of the electric drive device to a carcass rail,

FIG. 7a, 7b show the electric drive device according to the exemplary embodiment of FIG. 1b with a support for coupling to the carcass rail in a view from above and a perspective view,

FIG. 8a, 8b show the electric drive device according to the exemplary embodiment of FIG. 1b with disassembled housing in two perspective views from a front and a rear side,

FIG. 9, 10 show a distance measuring device of the electric drive device according to the embodiment of FIG. 1b in an exploded view and in a view from above with an enlarged detail in the area of position sensors,

FIG. 11, 12 show the electric drive device according to FIG. 8a in perspective view with enlarged detail in the area of a protective carcass in the housing for protecting a gear against abrasion from a belt as well as a belt drive with belt tensioners on both sides,

FIG. 13a, 13b show a gear arrangement of the electric drive device according to the embodiment of FIG. 1b in two perspective views,

FIG. 14a, 14b show a freewheel clutch of the electric drive device according to the embodiment of FIG. 1b in a plan view and a perspective view,

FIG. 15 shows a guiding mechanism according to a further preferred embodiment with an electric drive device arranged on one side in a perspective view,

FIG. 16 shows a diagram illustrating a clear position measurement or absolute distance measurement for a movable furniture part along a guiding mechanism by a distance measuring device according to the embodiment of FIG. 9 via sensor angle over extension lengths.

### DETAILED DESCRIPTION OF THE INVENTION

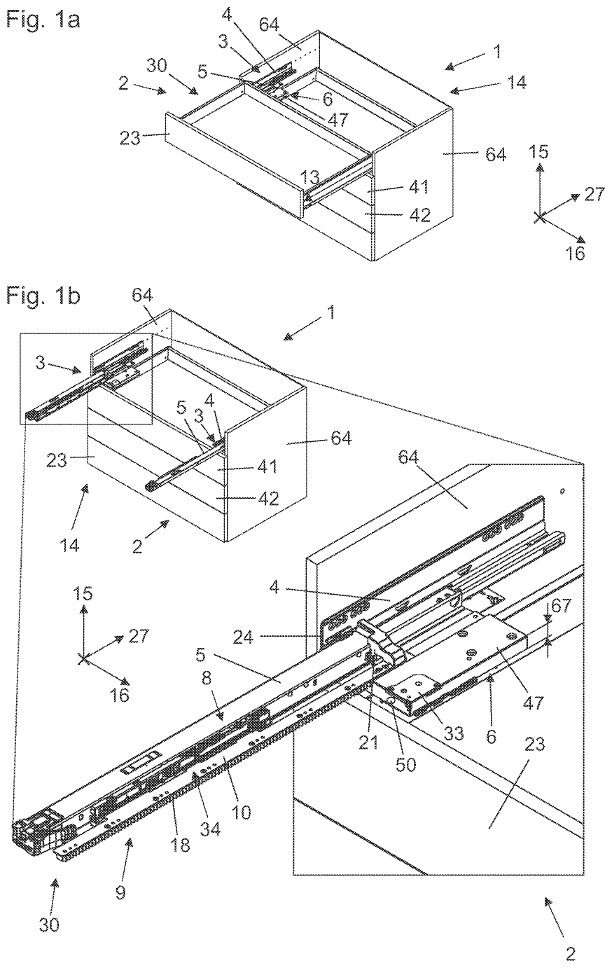

FIG. 1a shows a piece of furniture with movable furniture parts 2 in the form of drawers, which can be moved relative to a stationary furniture part 1 in the form of a furniture carcass via a guiding mechanism 3 in the form of a drawer pull-out guide by an electric drive device 6.

The movable furniture parts 2 can be divided into a first movable furniture part 41 and further movable furniture parts 42, wherein the further movable furniture parts 42 are arranged below the first movable furniture part 41 in the use position 14 of the arrangement.

However, the piece of furniture is not limited to drawers and can generally include other containers. For example, the furniture can be a furniture carcass with a flap, a cabinet with a folding and/or sliding door or the like.

FIG. 1b shows the furniture with a hidden movable furniture part 2 in an arrangement comprising the stationary furniture part 1, the furniture part 2 movable relative to the stationary furniture part 1 and two guiding mechanisms 3 for guiding the movable furniture part 2 relative to the stationary furniture part 1.

The arrangement comprises an electric drive device 6 for at least partially automated movement of the movable furniture part 2 relative to the stationary furniture part 1, comprising an electric motor 7 that can be supplied with 230 V. The energy supply for the electric motor 7 is generally arbitrary and can also be operated with different voltages. In general, a voltage may also be lower—particularly due to local or regional power grid characteristics—in order to supply the electric motor 7 with sufficient energy.

The guiding mechanisms 3 each comprise a carcass rail 4 arranged on the stationary furniture part 1 and a drawer rail 5 arranged on the movable furniture part 2. In general, a center rail can be arranged at least partially between the carcass rail 4 and the drawer rail 5, but this is generally not necessary—in particular for a full extension of the movable furniture part 2 due to the front-side arrangement of the electric drive device 6 and the connection to a rack 9.

In the detailed section, the connection of the electric drive device 6 to the carcass rail 4 and a toothed rack 9 to the drawer rail 5 is shown enlarged, wherein the drawer rail 5 comprises a first interface 34 (optionally a plurality of first interfaces 34) which is suitable for fixing an ejection device 11 and a closing device 8 to the drawer rail 5.

At the first interface 34, a closing device 8 is arranged, which is generally not required. Alternatively or additionally, an ejection device 11, in particular a mechanical or electrical one, can be arranged at the first interface 34. Preferably, the ejection device 11 comprises a tip-on function with which an ejection process can be released by an overpressure movement.

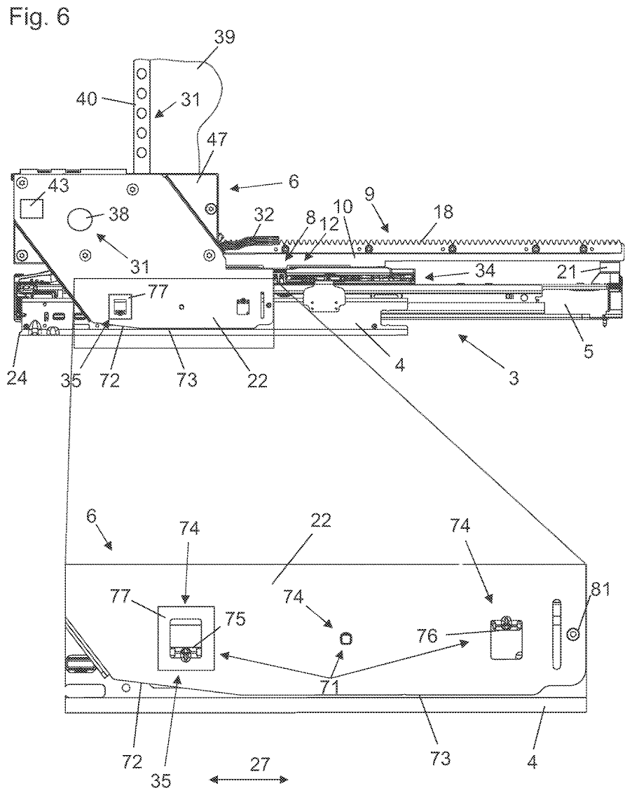

The carcass rail 4 comprises a second interface 35 (optionally a plurality of second interfaces 35) which is suitable for fixing a driver 36 for the ejection device 11 or the closing device 8 to the carcass rail 4. The second interface 35 is located (not visible in the view) on the underside of the cabinet rail 4 (see FIG. 6).

The electric drive device 6 is arranged at the second interface 35 and the rack 9 for transmitting power from the electric drive device 6 to the drawer rail 5 is arranged at the first interface 34.

The connection of the electric drive device 6 is made via a clip connection 71 and via a pivoting process for hanging (see FIG. 6). The connection of the rack 9 is effected via a clip connection 71 during a translatory insertion process into the closing device 8 or the drawer rail 5. For example, the clip connection 71 (on the rack 9, the closing device 8 or the drawer rail 5) can have a latchable web or a latching boss 81, wherein hooks 75 are generally also possible as an alternative or in addition. In the exemplary embodiment, the rack 9 is connected to the closing device 8, which may optionally have an ejection device 11 or to which an ejection device 11 may optionally be connected (replacing the closing device 8 is also conceivable). A direct connection of the rack 9 to the drawer rail 5 is also possible. An indirect connection of the electric drive device 8 (for example via a driver 36 for the closing device 8) is also possible, although a direct connection is preferred.

The rack 9 is to be designed so wide that equivalent means such as a belt (optionally with a toothing 18), a cable or the like for transmitting power between the electric drive device 6 and the drawer rail 5 are also included.

In the use position 14 of the arrangement, the electric drive device 6 is arranged substantially completely below the movable furniture part 2 on the carcass rail 4, wherein, if necessary, a furniture part front 23 (for example for contacting a release sensor 59) can protrude in the vertical direction 15 below an upper side of the electric drive device 6 or the electric drive device 6. A base of the movable furniture part 2 is arranged completely above the electric drive device during the movement of the movable furniture part. The movable furniture part 2 moves over the electric drive device 6 during use.

The electric drive device 6 is arranged stationary on the carcass rail 4 and is in constant connection to the rack 9 for movement transmission over an entire path 13 for the movable furniture part 2 along the guiding mechanism 3.

The movable furniture part 2 comprises a furniture part front 23, wherein the electric drive device 6 is arranged on the carcass rail 4 in the use position 14 of the arrangement in the region of a free end 24 of the carcass rail 4 facing the furniture part front 23.

In the closed position, the electric drive device 6 is arranged flush with the drawer rail 5 or the rack 9. The rack 9 can compensate for any loss of extension caused by the fastening of the cabinet rail and/or by the use of a specific release sensor type.

The electric drive device 6 is arranged substantially flush with the free end 24 of the cabinet rail 4 both in the closed position and in the open position 30.

The stationary furniture part 1 comprises two furniture panels 64 oriented vertically and parallel to one another in the use position 14, wherein exactly one electric drive device 6 is arranged stationary on one of the two furniture panels 64 indirectly via the carcass rail 4. In general, however, a further electric drive device 6 or an additional rack 9 can also be arranged on the opposite furniture panel 64, although this is not absolutely necessary.

In the use position 14 of the arrangement, the movable furniture part 2 comprises a furniture part front 23, wherein the electric drive device 6 is arranged on the carcass rail 4 in the region of a free end 24 of the carcass rail 4 facing the furniture part front 23 (essentially flush with the free end 24 or the drawer rail 5 in the closed position or the toothed rack 9 in the closed position).

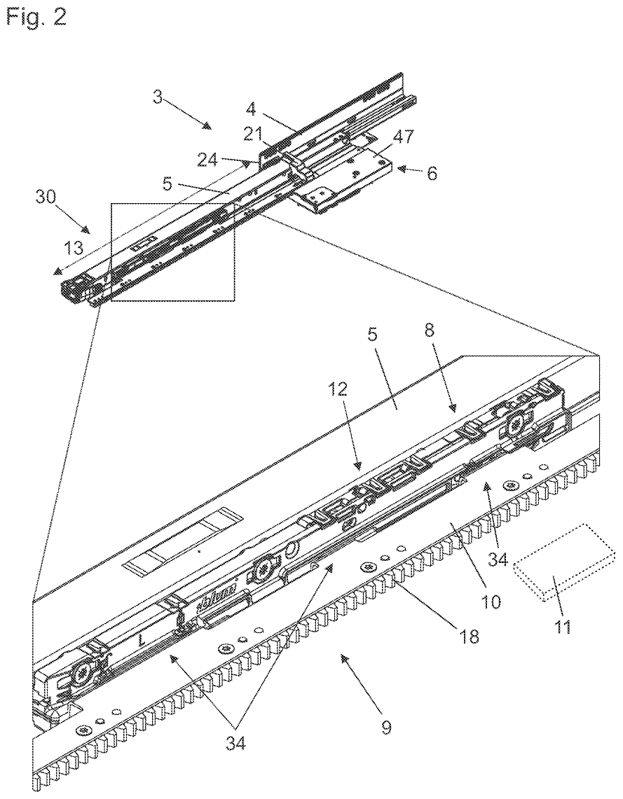

FIG. 2 shows the connection of the electric drive device 6 to the carcass rail 4 without surrounding furniture parts 1, 2, wherein the drawer rail 5 is fully extended over the path 13 as an extension path for the movable furniture part 2.

In the enlarged detail section, the connection of the rack 9 to the drawer rail 5 or the closing device 8 is visible, with an ejection device 11 being indicated in dotted line, which can be arranged alternatively or additionally at the first interface 34. It is also conceivable to provide a locking device 69 for inhibiting a movement of the movable furniture part 2 at the first interface 34. A damping device 12 is integrated in the closing device 8, whereby the damping device 12 can also be present as a separate component.

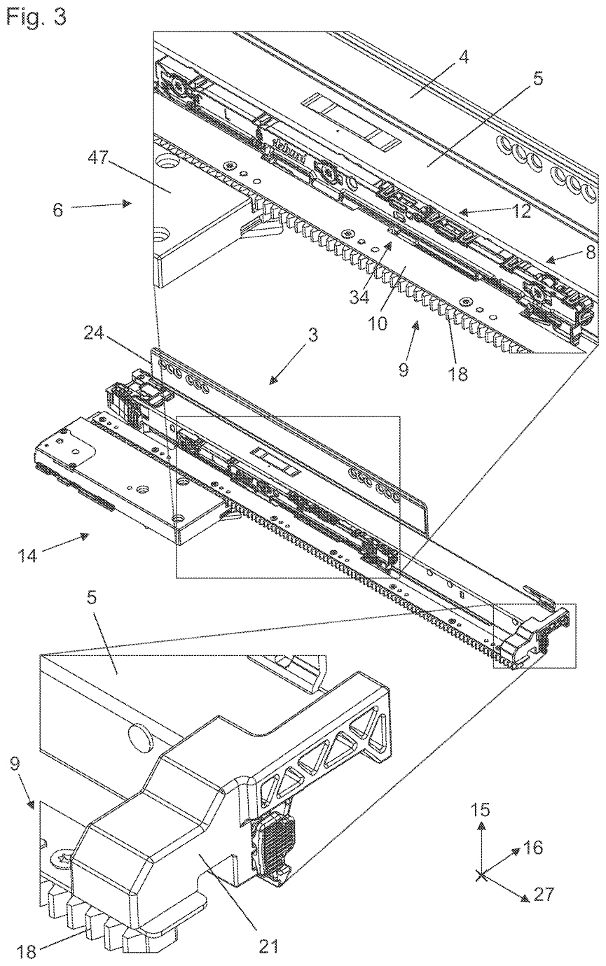

FIG. 3 shows the guiding mechanism 3 with the electric drive device 6 for the automated movement of the movable furniture part 2 or the drawer rail 5 with the electric motor 7 (which can be supplied with 230 V).

The closing device 8 for the movable furniture part 2 and the rack 9 operatively connected to the electric drive device 6 are mounted, wherein the closing device 8 is arranged directly on the drawer rail 5 and the rack 9 is arranged indirectly via the closing device 8 on the first interface 34 of the drawer rail 5. In general, the rack 9 can alternatively or additionally directly contact the drawer rail 5.

The rack 9 is detachably arranged on a support device 10 and the support device 10 is detachably arranged on the closing device 8.

In this context, the detachable connection of the support device 10 means a connection that can be released without force, preferably without tools.

The support device 10 is arranged in the horizontal direction 16 between the rack 9 and the closing device 8, wherein in general a rack 9 pointing downwards in the vertical direction 15 can also be provided.

The support device 10 or the closing device 8 can comprise a mechanical or electrical ejection device 11, wherein a damping device 12 in the closing device 8 for damping a movement of the movable furniture part 2 in a region of the closed position.

The stationary electric drive device 6 is in constant connection to the rack 9 for transmitting movement over the entire path 13 along the guiding mechanism 3, wherein the electric drive device 6 comprises a gear 17 meshing with the rack 9 in connection with the electric motor 7.

The rack 9 is arranged laterally between the electric drive device 6 and the drawer rail 5 over the entire path 13.

In this embodiment, exactly one electric drive device 6 is provided on one of the two carcass rails 4 of the guiding mechanisms 3 and exactly one rack 9 is provided on one of the two drawer rails 5 of the guiding mechanisms 3, wherein in general two electric drive devices 6 can also be used on both carcass rails 4.

A power supply to the electric drive device 6 or to any additional power sink present—such as the lighting means 31 in FIG. 6—is provided via the carcass rail 4, wherein the power supply can alternatively or additionally be provided via the rack 9. The power supply can be routed between the two carcass rails 4 of the two provided guiding mechanisms 3 in order, for example, to supply energy to a further release sensor 65. A separate power supply per cabinet rail 4 (or rack 9) is also possible.

A toothing 18 of the rack 9 is oriented in the use position 14 of the arrangement in the horizontal direction 16 in a direction pointing away from the drawer rail 5, whereby in general an orientation in the vertical direction 15 downwards is also possible.

The rack 9 is coupled to the gear 17 of the electric drive device 6, wherein the rack 9 (via a connection to the support device 10 or by the connection of the support device 10) is bent in the horizontal direction 16 relative to the drawer rail 5 (pivoting is also conceivable) and is thus mounted for limited lateral movement. For example, the rack 9 could also be mounted to be movable to a limited extent in the vertical direction 15 (away from the gear 17) even with a vertical toothing 18 in the vertical direction 15. This enables a secure coupling with the elastic drive device 6, while also reducing assembly effort due to a reduced tendency to tilt and noise generation due to elastic or flexible deformation. For example, the rack 9 can be preloaded in the direction of the gear 17 by a spring or by its own elasticity in order to ensure a positive connection to the electric drive device 6 during operation.

Particularly preferably, the rack 9 is designed to be flexible in order to be able to ensure a safe, harmonious and continuous transmission of movement through elastic deformation.

Due to the detachable connection—in particular the double detachable connection—an overload clutch can be constituted via the component parts involved, whereby an overload clutch 68 of the electric drive unit 6 can be dispensed with. For example, a tolerance in the interaction between the gear wheel 17 and the rack 9 caused by increased loading of the rack 2 (for example in the event of vibrations or improper forces acting on the movable furniture part 2) can prevent a complete decoupling between the electric drive device 6 and the rack 9 from occurring-without losing the effect of an overload clutch, whereby the position of the drawer rail 5 relative to the carcass rail 4 remains clearly determinable via the relative position between the rack 9 and the gear wheel 17. Decoupling from the electric motor 7 is not required and can be generated, for example, via a freewheel clutch 29. A required reference run can be prevented, with the support device 10 acting as a coupling device.

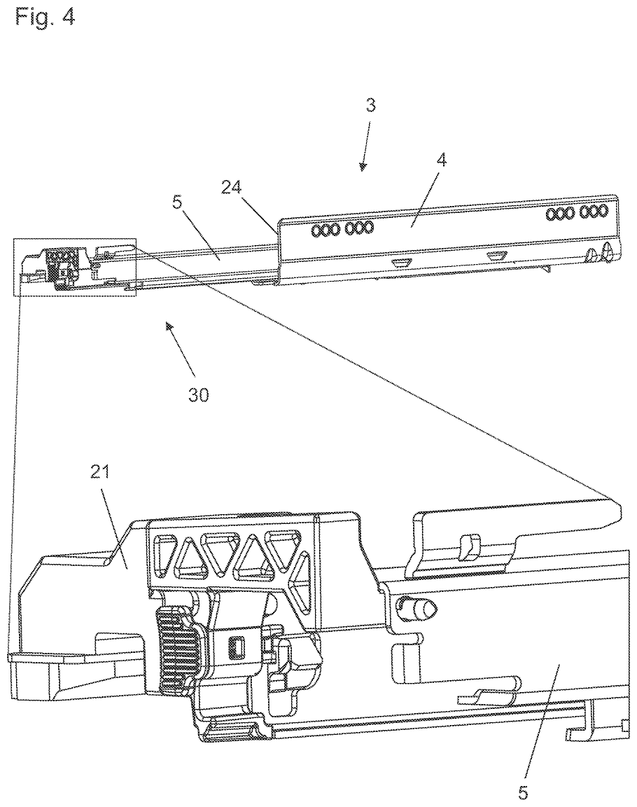

FIG. 4 shows the guiding mechanism 3 with an enlarged detail of the drawer rail 5 in the area of a coupling device on the rear side of the furniture part for the movable furniture part 2.

The drawer rail 5 comprises a bearing device 21 for the rack 9, wherein the bearing device 21 is arranged on the drawer rail 5 and the rack 9, wherein a support 22 of the electric drive device 6 for connecting the electric drive device 6 to the carcass rail 4 can be traversed by the rack 9 and the bearing device 21 in the course of a relative movement between the drawer rail 5 and the carcass rail 4.

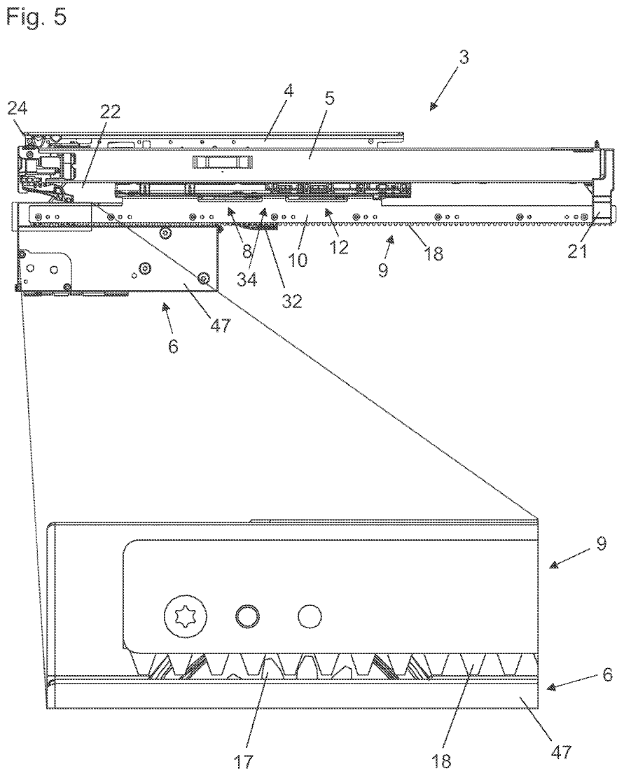

FIG. 5 shows the guiding mechanism 3, wherein the coupling between a gear 17 of the electric drive device 6, which is in operative connection with the electric motor 7, and a toothing 18 of the rack 9 is shown in an enlarged detail section.

The electric motor 7 (or the electric drive device 6) comprises, in the coupling with gear stages 55 of the electric drive device 6, a gear 17 meshing with the rack 9.

In the position of use 14 of the arrangement, the gear wheel 17 is oriented in the horizontal direction 16 in the direction of the drawer rail 5, whereby a gear wheel 17 of the electric drive device 6 oriented upwards in the vertical direction 15 is also possible.

The rack 9 is arranged between the electric drive device 6 and the drawer rail 5. The guiding mechanism 3 is in the closed position, whereby a movable furniture part 2 arranged on the drawer rail 5 would be located in an end position.

In order to improve a degree of force transmission by the energy transmitted via the electric drive device 6 to the movable furniture part with regard to a time and/or an intensity, the electric drive device is controlled by a microcontroller 37, which functions as a control and/or regulating device 44 and acts as a computer.

An exemplary computer-assisted method for moving the movable furniture part 2 relative to the stationary furniture part 1 along the guiding mechanism 3 by the electric drive device 6 for at least partially automated movement of the movable furniture part 2 relative to the stationary furniture part 1 via an electric motor 17 can be implemented as follows: The microcontroller 37, comprising the computer and a memory unit connected to the computer, determines a model of the movable furniture part 2 depending on at least one static dataset stored in the memory unit, the movable furniture part 2 is moved manually from a partial or complete opening position 30 and a closing position towards the closing position or vice versa, and the microcontroller 37 calculates a predicted movement trajectory of the movable furniture part 2 along the guiding mechanism 3 depending on at least one dynamic dataset.

The static dataset can include, for example, a mass of the movable furniture part 2, a friction of the movable furniture part 2 on the guiding mechanism 3, a dimensioning of the movable furniture part 2, a load in the movable furniture part 2, a dimensioning of the guiding mechanism 3, a path 13 along the guiding mechanism 3, tolerance limits, etc.

The path 13 can generally be determined by an extension path for the movable furniture part 2 or a longitudinal extension of the rack 9, via which at least a partial drive is effected by the electric drive device 6 via an automated control. A drive over path 13 is possible; a drive over parts of path 13 is preferred.

The dynamic dataset can, for example, include an absolute path traveled by the movable furniture part 2 relative to the stationary furniture part 1, a speed of the movable furniture part 2, a load in the movable furniture part 2, an acceleration profile of the movable furniture part 2 (generally determined via a speed measuring device 52), an acceleration path of the movable furniture part 2, a kinetic energy of the movable furniture part 2, etc.

The static dataset or the dynamic dataset can be determined in a reference run of the movable furniture part 2 or via a plurality of reference runs-possibly with varying loads of the movable furniture part 2. Alternatively or additionally, it is possible to store static data records in a storage unit without a reference run and to compare static data records or dynamic data records with data records stored in the storage unit or to correct them depending on the stored data records.

The following aspects are provided for in this embodiment, but do not necessarily have to be implemented:

Depending on the predicted movement trajectory, the microcontroller 37 makes a decision as to whether the electric drive device 6 should apply force to the movable furniture part 2 or whether the movable furniture part 2 should be movable manually in a free-running area. The electric motor 7 comprises a freewheel clutch 29, with which a power transmission from the electric motor 7 to the movable furniture part 2 is separated in the freewheel area.

The microcontroller 37 calculates, depending on the at least one static dataset and the at least one dynamic dataset, whether the movable furniture part 2 reaches the closed position without application of force via the electric drive device 6, wherein a speed of the movable furniture part 2 upon entry into the closed position is determined as a function of a damping power of a damping device 12 arranged on the movable furniture part 2 or the stationary furniture part 1.

Depending on the predicted movement trajectory, the microcontroller 37 defines a speed profile for the drive of the movable furniture part 2 mediated via the electric drive device 6, wherein the electric drive device 6 applies force to the movable furniture part 2 depending on the speed profile. The speed profile is created as a function of the at least one static dataset or the at least one dynamic dataset, wherein the movable furniture part 2 is supplied with energy at a speed of the movable furniture part 2 below the speed profile and is braked by the electric drive device 6 at a speed of the movable furniture part 2 above the speed profile, and a force transmission to the movable furniture part 2 is initiated at a predefined speed threshold value or a predefined position threshold value.

The microcontroller 37 is equipped with a learning algorithm in the form of artificial intelligence comprising a neural network with machine learning or deep learning, whereby the learning algorithm analyzes and compares the predicted movement trajectories of a history. The history of predicted movement trajectories is used, depending on the respective static datasets or dynamic datasets, for future movement trajectories to be predicted, future speed profiles or future decisions regarding the application of force to the movable furniture part 2.

Movement sequences of the movable furniture part 2 along a guiding mechanism 3 are used as training data for the artificial intelligence. It has proven particularly advantageous if different guiding mechanisms 3 and varying force applications or loads of the movable furniture part 2 are used to train the learning algorithm. Movement sequences on the specific guiding mechanism and the specific movable furniture part 2 can be added to the training data—in particular continuously—for learning purposes.

The electric drive device 6 remains stationary on the carcass rail 4 during movement of the movable furniture part 2 and is in constant connection with the rack 9 arranged on the drawer rail 5.

The movable furniture part 2 can be driven via the drawer rail 5 starting from the open position 30 or a position between the open position 30 and the closed position over an entire path 13 up to the closed position and to the open position 30 or only over a partial area of the path 13 by the electric drive device 6, wherein a force application by the electric drive device 6 starting from the closed position in the direction of the open position 30 is initiated by an overpressure movement of the movable furniture part 2 or via an exclusively electronic release sensor 59. The movable furniture part 2 can be moved manually in a non-driven section of the path 13 in a free-running area, so that no force is applied by the electric motor 7 to the movable furniture part 2.

Driven sections of the path 13 have proven to be particularly advantageous in the direction of the opening position 30—in particular starting from the closing position-between 50 mm and 150 mm and in the direction of the closing position—in particular starting from the fully opening position 30—between 5 mm and 20 mm.

A movement of the movable furniture part 2 in the direction of the closed position or the open position 30 can be damped, braked or blocked via the electric drive device 6, wherein the movable furniture part 2 is subjected to force in the direction of the closed position by a closing device 8 in the region of the closed position. However, a closing device 8 is not absolutely necessary, and the closing device 8 can be replaced, for example, by the electric drive device 6.

An algorithm or a computer program product comprising instructions for executing the method can be stored in the microcontroller 37 or the control and/or regulating device 44, transmitted on a data support signal or stored on a—in particular non-volatile—data support.

The computer of the microcontroller 37 or of the control and/or regulating device 44 is configured to determine a model of the movable furniture part 2 as a function of the at least one static dataset stored in the memory unit and to calculate a predicted movement trajectory of the movable furniture part 2 along the guiding mechanism 3 as a function of the at least one dynamic dataset, possibly stored in the memory unit. The electric drive device 6 comprises the computer.

The storage unit has sufficient storage capacity to provide the information required for the model. The computer has sufficient computing power to calculate the model with the accuracy required for application in the furniture industry with respect to a speed profile to be transferred to the movable furniture part 2. The storage capacity and the computing power can be adjusted depending on the desired precision of the model or the desired accuracy of an output parameter to be generated from the model, such as the velocity profile.

The speed profile preferably comprises an amplitude of the acceleration, a path of the acceleration, the path 13 or a portion of the path 13 over which the movable furniture part 2 is to be subjected to speed or is to be driven, a maximum speed and the like. As input parameters, for example, a current load of the movable furniture part 2 or a pulse transmission (discrete or continuous) from the operator of the movable furniture part 2 can be used as a dynamic parameter.

By means of the method and in particular the microcontroller 37 or the control and/or regulating device 44, a support detection for a movement of the movable furniture part 2 can be generated, wherein the movable furniture part 2 can be driven in the closing direction or in the opening direction, for example, in such a way that the movable furniture part 2 is moved into an end position (closed position or open position 30) essentially silently and/or without significant force acting on the component parts. In general, a partial drive or a complete drive—in particular over the entire travel distance 13—into the end position is possible.

Due to the increased functionality of the method compared to the prior art, undesirable disharmonious movement trajectories can be prevented—in particular with changing force applications and/or loads of the movable furniture part 2 or varying guiding mechanisms 3—whereby improperly high or low speeds of the movable furniture part 2 can be prevented, which do not allow movement into a desired end position of the movable furniture part 2 or can cause damage.

The microcontroller 37 can be understood as a control and/or regulating device 44 or can comprise such a computer.

FIG. 6 shows that the electric drive device 6 comprises a plurality of illumination means 31 which are stationary relative to the stationary furniture part 1, wherein in general only one illumination means 31 can be provided. The lighting means 31 is arranged on the electric drive device 6.

A lighting means 31 is in the form of a lamp 38—designed as an LED lamp—and is integrated in the electric drive device 6 in some areas in the housing 47 of the electric drive device 6.

A further illumination means 31 is in the form of a strip-like illuminant 40—designed as an LED strip—and is arranged directly on the electric drive device 6. The dotted line indicates that the further illumination means 31 can also be in the form of a flat illuminant 39—here intended as an LED surface—can be present. For example, the further lighting means 31 can also be arranged indirectly on the electric drive device 6—for example by connecting a power line 32 (not shown for reasons of clarity) to the power line 32 of the electric drive device 6.

The lighting means 31 are oriented on an underside of the electric drive device 6 in such a way that the further movable furniture parts 42 can be illuminated by the lighting means 31, wherein the lighting means 31 are arranged on the electric drive device 6 of the first movable furniture part 41. However, the lighting means 31 can generally be arranged alternatively or additionally on the electric drive device 6 or the power line 32 of the electric drive device 6 of the first movable furniture part 41 in such a way that the first movable furniture part 41 can be illuminated by the lighting means 31.

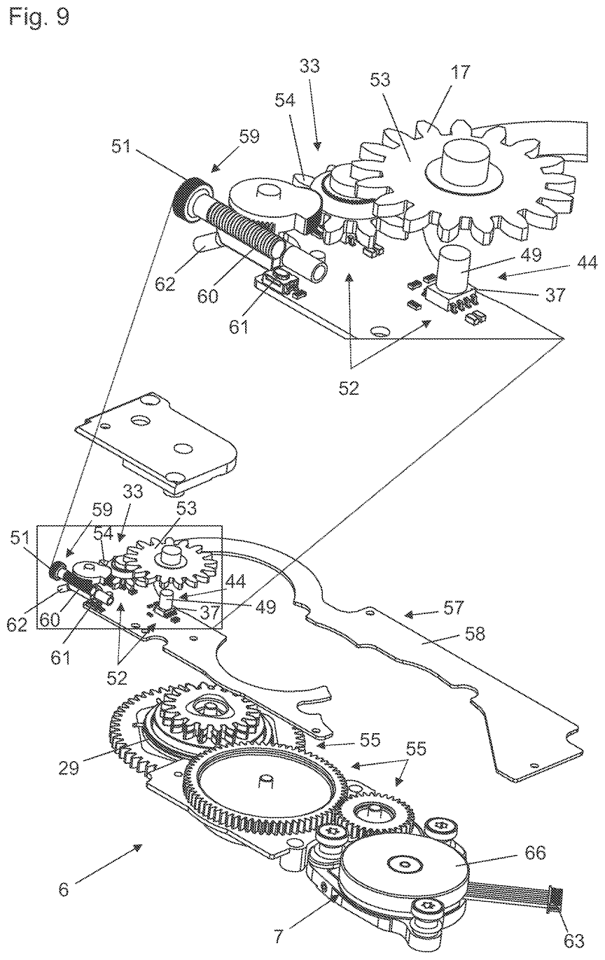

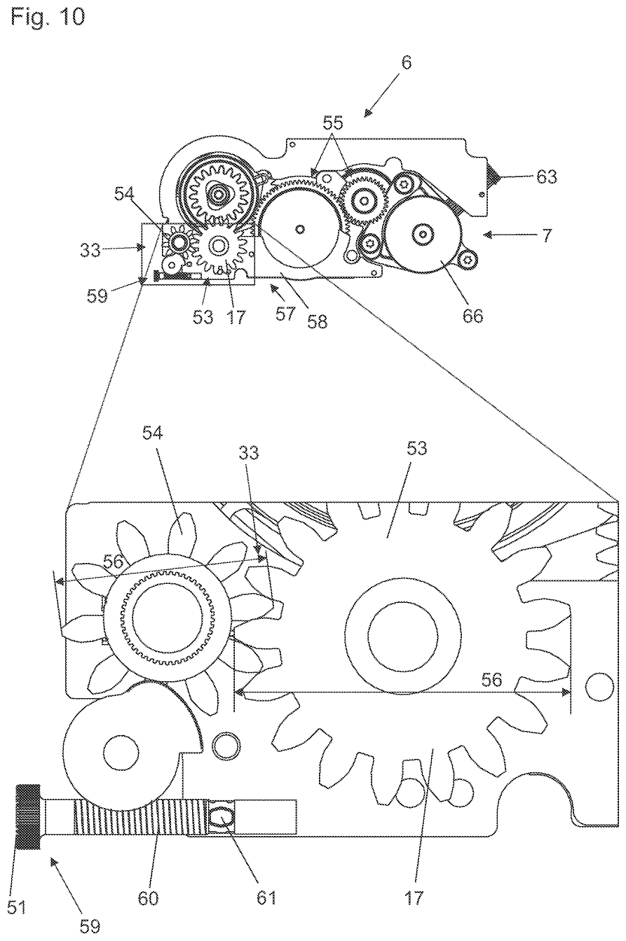

As will be explained in more detail in FIG. 9 and FIG. 10, a displacement measuring device 33 is provided, which can be used alternatively or in addition to the schematically indicated motion sensor 43 in order to detect a relative position-such as a complete or partial opening position 30 of the movable furniture part 2 relative to the stationary furniture part 1. The lighting means 31 can be activated by a control and/or regulating device 44 or a microcontroller 37 depending on the determined relative position. The distance measuring device 33 and the motion sensor 43 are arranged on the electric drive device 6 and coupled to the power line 32 of the electric drive device 6 and the lighting means 31. In general, the distance sensor 50 (see FIG. 1b) can be used alternatively or in addition to the distance measuring device 33 or the motion sensor 43 to determine the relative position for releasing the lighting means 31. The number of lighting devices 31 is generally arbitrary.

The lighting means 31 are arranged between the two carcass rails 4 of the guiding mechanism 3, wherein the strip-like lighting means 40 is located laterally between the carcass rails 4 and extends completely linearly between the two carcass rails 4.

There is a direct power connection between the two carcass rails 4, which can be used to illuminate the movable furniture part 2, wherein the power connection or the power supply is routed via at least one of the two carcass rails 4 or the rack 9. The electric drive device 6 is arranged stationary on one of the two carcass rails 4 and the rack 9 is arranged on the drawer rail 5 of the guiding mechanism 3 for the continuous transmission of movement from a gear wheel 17 of the electric drive device 6 to the drawer rail 5. The electric drive device 6 and the power line 32 for the electric drive device 6 and for the lighting means 31 are arranged stationary on the guiding mechanism 3—on the carcass rail 4.

The movable furniture part 2 can be subjected to force via the electric drive device 6 via a control and/or regulating device 44 or a microcontroller 37, so that the connection to the carcass rail 4 has a dual function. The electric drive device 6 is designed to move the movable furniture part 2 at least in regions relative to the stationary furniture part 1, wherein the electric drive device 6 comprises the lighting means 31 arranged on the electric drive device 6 or the power line 32 of the electric drive device 6.

An exemplary method for illuminating a movable furniture part 2 (optionally the further movable furniture part 42) can be explained as follows: The movable furniture part 2 is moved relative to the stationary furniture part 1 along the guiding mechanism 3 by the one electric drive device 6 in an automated manner, at least in some areas, and the lighting means 31 arranged on the electric drive device 6 or on the power line 32 of the electric drive device 6 is activated, so that the movable furniture part 2 is illuminated by the lighting means 31, wherein the movable furniture part 2 is moved and the lighting means 31 remains stationary. In particular, the further movable furniture part 42 is illuminated by the lighting means 31 in dependence on a movement of the first movable furniture part 41, wherein the lighting means 31 remains stationary on the electric drive device 6 of the first movable furniture part 41. For this purpose, the relative position of the further movable furniture part 42 can be detected, wherein the lighting means 31 is activated via a control and/or regulating device 44 or the microcontroller 37 as a function of the determined relative position. For example, an algorithm or a computer program product can be stored in the control and/or regulating device 44 or the microcontroller 37, which comprises instructions which, when executed by a computer, cause the computer to execute the method from a memory unit which has a data connection with the computer.

Preferably, light is emitted in the visible wavelength range, wherein, for example, it can be provided that a wavelength range and/or an intensity of the illumination means 31 is changeable and/or adjustable-optionally via the electric drive device 6 or a receiving unit of the electric drive device 6 for configuring the electric drive device 6.

In general, a lighting means 31 can alternatively or additionally emit, for example, light in the infrared range for heating or light in the UV wavelength range—in particular UVC wavelength range—for sterilization or disinfection. In this way, stored goods or a surface can be freed from unwanted microorganisms or an interior of the movable furniture part 2 can be regulated to a desired temperature in order, for example, to be able to irradiate food—in particular in combination with a vacuum drawer and optionally adjustable—with varying intensity or adjustable wavelength range. Positioning on a stationary electric drive device 6 above the storage space is particularly suitable for this purpose. A locking device depending on activation of the lighting means 31 is also conceivable.

In principle, an energy supply by introducing electricity into the movable furniture part 2 is complex and cumbersome, since the movement of the movable furniture part 2 must be taken into account. However, lighting of the movable furniture part 2 has the advantage of being able to clearly identify stored items in the movable furniture part 2—particularly in poor lighting conditions or at night. In particular, in the case of an electrical drive device 6 arranged in a fixed position on the carcass rail 4, the introduction of current via the carcass rail 4 can also be used in a dual function to use energy for supplying the lighting means 31 in a particularly advantageous manner.

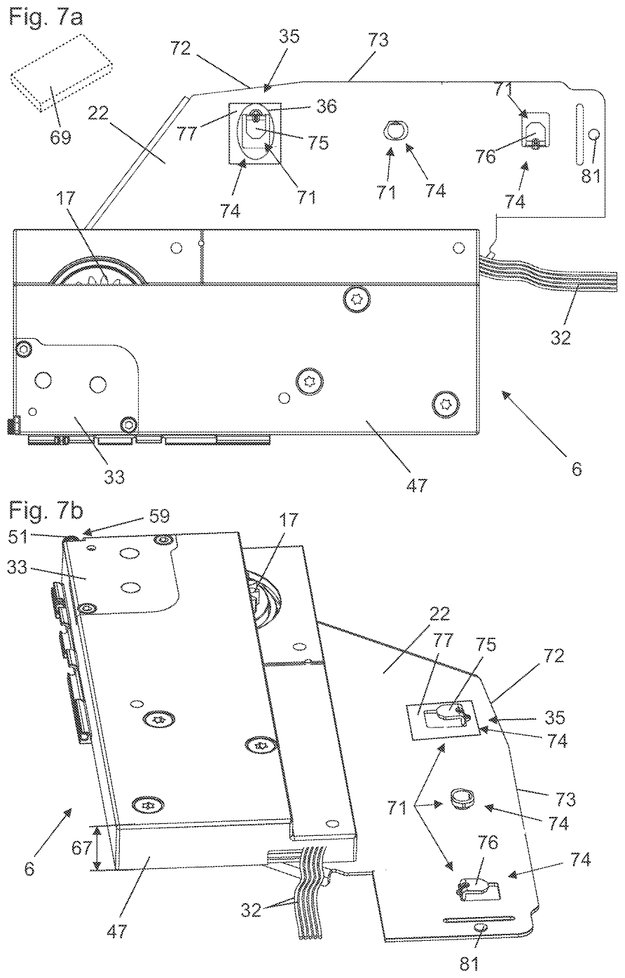

FIG. 7a shows an electric drive device 6 with the electric motor 7 which can be supplied with 230 V, wherein the electric drive device 6 comprises a plate-shaped support 22 for arrangement on the carcass rail 4 of the guiding mechanism 3, wherein the support 22 comprises an inclined surface 72 which is such that the electric drive device 6 can be mounted on a carcass rail 4 arranged on the stationary furniture part 1 in the assembled state (cf. FIG. 6 in conjunction with FIG. 1b) in a collision-free manner via a pivoting-in process.

The electric drive device 6 has a longitudinal direction 27 and the inclined surface 72 of the support 22 is oriented at an acute angle between 5° and 30° relative to the longitudinal direction 27.

The inclined surface 72 for arrangement on the carcass rail 4 is arranged on a free end 73 of the support 22 projecting transversely from the electric drive unit 6 and spatially spaced from the electric drive device 6 and the electric motor 7.

The electric drive device 6 comprises two coupling devices 74 on the support 22 for connection to a second interface 35 of the carcass rail 4, wherein generally one coupling device 74 is sufficient. A coupling device 74 is in the form of a hook 75 punched and bent from a sheet metal, wherein a further hook 76 is provided on the support 22 as a counter bearing for the connection of the electrical drive device 6 to the carcass rail 4. For example, a driver 36 for the closing device 8 or an ejection device 11 (optionally with tip-on function) can be arranged on the further hook 76. The further hook 76 can be used as a second interface 35.

A further coupling device 74 is present (analogous to the two coupling devices 74 as hook/further hook 75, 76) as clip connection 71. The further coupling device 74 is designed as a locking hump 81. The electric drive device 6 can be plugged translationally onto the cabinet rail 4 via the locking boss 81 and the support 22 and can be securely fixed to the cabinet rail 4 via the two hooks in a pivoting process, wherein in general a secure fixing can already be achieved via the locking boss 81.

During assembly, the locking boss 81 can elastically engage a corresponding recess for fixing purposes due to a recess provided in the material to the side. Between the hooks 75, 76, an extension is visible, which acts as a rotation axis for a rotational movement after translational contact. In general, fixation can also be provided, for example, by a snap-in bridge via a purely translational movement in the sense of a clip connection.

The coupling device 72 in the form of the hook 75 overlaps with an opening 77 of the support 22. The opening 77 has a dual function in connection with a manufacturing process of the support 22, since the opening 77 can be used, for example, as a holding device (for example for handling or coating) in production. The opening 77 can generally be arranged alternatively or additionally on the carcass rail 4, whereby the dual function with regard to the connection and the manufacturing process can also be used here. The hook 75 projects through the opening 77 of the support 22 (or the carcass rail 4). The electric drive device 6 can generally be arranged indirectly via the support 22 on the carcass rail 4. The support 22 can be formed in several parts. The hook 75 or the locking boss 81 can generally be arranged as a kinematic reversal on the carcass rail 4. The opening 77 or a multi-part structure of the support 22 is generally not required. Preferably, there is an opening 77 in the carcass rail 4 into which the hook 75 engages, this opening 77 defining the position of the carcass rail 4 in a system for manufacturing the carcass rail 4. Another movement technology can be connected to the hook 74.

An exemplary method for retrofitting the electric drive device 6 to the guiding mechanism 3 in the installed state of the guiding mechanism 3 can be explained as follows: The electric drive device 6 for at least partially automated movement of the movable furniture part 2 is provided and the guiding mechanism 3 is mounted on the stationary furniture part 1 (see FIG. 1a) for guiding the movable furniture part 2 relative to the stationary furniture part 1, wherein, if necessary, an ejection device 11, a closing device 8, a driver 36 for the ejection device 11 or a driver 36 for the closing device 8 is removed from the guiding mechanism 3. Subsequently, the electric drive device 6 is arranged essentially completely (optionally with the furniture part front 23 projecting downwards) below the movable furniture part 2 to be moved at the second interface 35 of the carcass rail 4 and the toothed rack 9 is arranged at the first interface 34 of the drawer rail 5 for transmitting power from the electric drive device 6 to the drawer rail 5.

The first interface 34 of the drawer rail 5 can generally be provided by a closing device 8.

At the second interface 35, a locking device 69 (schematically indicated in dotted lines) for blocking a movement of the movable furniture part 2 relative to the stationary furniture part 1 and a driver 36 for an ejection device 11 can be arranged. The driver 36 for the closing device 8 provided in this embodiment is indicated in dotted line at the second interface.

The inclined surface 72 reduces the risk of a collision with the stationary furniture part 1 or the carcass rail 4 during the assembly of the electric drive device 6 on the carcass rail 4, wherein the electric drive device 6 can be connected as an add-on to existing guiding mechanisms 3. The rack 9 (or equivalent) can also be subsequently coupled to the drawer rail 9 to transmit movement from the electric drive device 6 to the movable furniture part 2. The interfaces 34, 35 in conjunction with the components to be arranged thereon therefore comprise a multifunctionality-on the one hand to ensure user-friendly retrofitting and on the other hand to connect a variety of flexibly interchangeable and varying movement technologies. This avoids the need for multiple interfaces for a variety of motion technologies, while individual motion technologies can be easily connected as add-ons. Additional installation space for the arrangement of the electric drive device 6 does not have to be provided, whereby the energy supply for the movable furniture part 2 and a sufficient transmission of movement to the movable furniture part 2 is also facilitated.

This is linked to a second aspect (linked via a synergy effect of the technical effects), which concerns a comfortable and (particularly in terms of available storage space) resource-saving attachment of the electric drive device 6, wherein—in particular via the connection to the carcass rail 4 and/or through an expedient gear design and/or selection of the electric motor 7—the electric drive device 6 can be located in a compact or narrow design below the movable furniture part 2. This allows the depth of the stationary furniture part 1 to be optimally utilized and a movable power supply is not required.

FIG. 7b differs from FIG. 7a only in that the electric drive device 6 is shown in a perspective view.

The electric motor 7 is arranged within a housing 47 with a thickness 67 in the vertical direction 15 in the position of use 14 of the arrangement below 100 mm. It is possible to achieve thicknesses 67 below 80 mm. The thickness 67 is preferably below 60 mm (and is also conceivable below 40 mm), so that in conventional furniture a furniture part front 23 protrudes below the underside of the electric drive device 6.

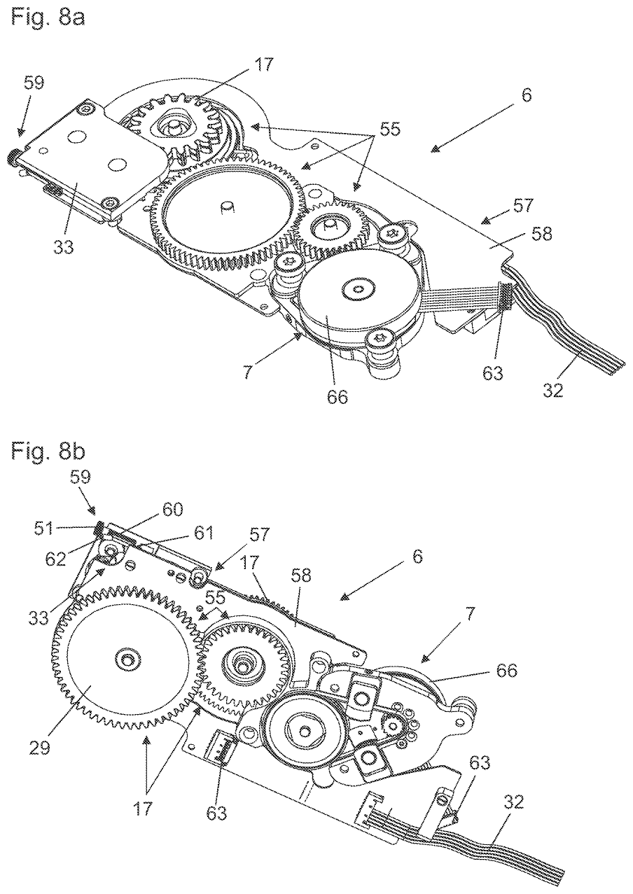

FIG. 8a shows that the electric motor 7 of the electric drive device 6 is in the form of a brushless external rotor motor 66, wherein in general also brushed external rotor motors 66, disc rotor motors or rod motors can be provided. External rotor motors and disc rotor motors have a particularly flat design and are therefore preferred.

The electric motor 7 is connected to a plurality of gear stages 55 with gear wheels 17 for driving the movable furniture part 2. By configuring the gear stages 55, a thickness of 67 can be further reduced and the other dimensions can also be made compact.

FIG. 8b differs from FIG. 8 only in that the components of the electric drive device 6 that are operatively connected to the electric motor 7 are viewed from a different angle.

The electric drive device 6 comprises a data interface 63 for the wired transmission of at least one digital dataset stored in a memory unit, wherein the data interface 63 can generally be designed as an alternative or in addition to the radio signal-transmitting transmission of the digital dataset.

The electric drive device 6 comprises a release sensor 59 for activating the electric motor 7 for a closed position of the movable furniture part 2, wherein the electric drive device 6 has a housing 47 which is disassembled in the illustration and the release sensor 59 is arranged on the housing 47 for contacting the movable furniture part 2 in the use position 14 of the electric drive device 6. The release sensor 59 comprises a plunger 60 and a microswitch 61, which can be released tactilely and electronically via the microswitch 61. An exclusively electronically actuated release sensor 59 may be provided alternatively or in addition.

FIG. 9 shows a distance measuring device 33 for the arrangement, wherein the distance measuring device 33 is designed to determine a position of the movable furniture part 2 relative to the stationary furniture part 1 and the position in the form of an absolute distance traveled by the movable furniture part 2 relative to the stationary furniture part 1 can be clearly determined by the distance measuring device 33.

The electric drive device 6 comprises an electric motor 7 which can be supplied with 230 V for the at least partially automated movement of the movable furniture part 2 relative to the stationary furniture part 1, wherein the position measuring device 33 is arranged on the electric drive device 6 or represents an integral component of the drive device 6 in interaction with the electric motor 7 and is integrated in the housing 47 of the electric drive device 6. However, an arrangement within the housing 47 is not absolutely necessary.

The movable furniture part 2 is translationally movable along the guiding mechanism 3 relative to the stationary furniture part 1 over the path 13 between the closed position and the open position 30 and can be driven over the entire path 13 by the electric drive device 6. The position measuring device 33 is provided for determining a position of the movable furniture part 2 relative to the stationary furniture part 1, wherein a relative position can be clearly determined via the position measuring device 33.

The position measuring device 33 comprises potentiometers 49 in the form of rotary potentiometers for determining the position, whereby Hall sensors (magnet in conjunction with Hall electronics) have proven to be particularly advantageous in the underlying electronics. Alternatively or additionally, a distance sensor 50—for example a distance laser—can be provided. The distance sensor system 50 can generally also be located spatially spaced from the electric drive device 6. The position measuring device 33 is arranged on the electric drive device 6.

The absolute path is determined starting from a predefined reference position, wherein the reference position is in the form of a relative position between the movable furniture part 2 and the stationary furniture part 1—in this embodiment given as stop 51 for the detection of an end position of the movable furniture part 2—or a reference position of the electric drive device 6—in this embodiment given as a starting position of the gear wheels 17 in connection with the electric motor 7.

A speed measuring device 52 is provided in the form of a potentiometer 49 arranged on the electric motor 7 or integrated in a control and/or regulating device 44 or a microcontroller 35. The speed measuring device 52 is used to determine a speed of the movable furniture part 2 relative to the stationary furniture part 1, wherein the movable furniture part 2 can be driven by the electric drive device 6 with a speed profile adapted to the determined speed of the movable furniture part 2 and/or the determined absolute path.

The control and/or regulating device 44 or the microcontroller 37 can be used to activate the electric motor 7 at a predefined speed determined by the speed measuring device 52 or at a predefined absolute distance determined by the at least one distance measuring device 33.

The position in the form of the absolute distance traveled is stored as a dynamic dataset and the speed as a dynamic dataset for simulating the model via the computer of the microcontroller 37 or the control and/or regulation unit 44, at least temporarily in the memory unit.

The position measuring device 33 comprises a first position sensor 53 in the form of a sensor wheel designed as a gear 17 and a further position sensor 54 in the form of a further sensor wheel designed as a gear 17, wherein the absolute path can be clearly determined via a relative rotational position of the position sensors 53, 54.

The first position sensor 53 and the further position sensor 54 are in the form of gear stages 55 of the electric drive device 6, wherein these gear stages 55 are not required for a transmission of the drive from the electric motor 7 to the drawer rail 5; for this purpose, further gear stages 55 are used. A transmission ratio in the range between 1.01:1 and 1.2:1 that can be used for the position measuring device 33 can be transmitted via the first sensor wheel. A gear ratio in the range between 1.2:1 and 2.3:1 can be achieved between the first sensor wheel and the further sensor wheel, and a gear ratio in the range between 1.5:1 and 2:1 can be achieved between the first sensor wheel and the further sensor wheel.

The sensor wheels as position sensors 53, 54 are designed as gear wheels 17, which, however, are not required for the engagement of the electric drive device 6 in the rack 9. The diameter 56 of the first sensor wheel differs from a diameter 56 of the second sensor wheel, whereby an absolute distance of up to 1200 mm can be clearly determined by the distance measuring device 33.

The absolute path of the movable furniture part 2 is determined starting from a reference position via a sum or a difference of rotation angles of the two position sensors 53, 54, so that a distancing between the movable furniture part 2 and the stationary furniture part 1 can be clearly calculated.

The position measuring device 33 comprises a magnetic bearing 57 over the housing 47 of the electric drive device 6 and a plastic part 58. The plastic part 58 acts as a dual function circuit board for a microcontroller 37.

The distance measuring device 33 comprises a tactile release sensor 59 in the form of a plunger 60 and a microswitch 61, wherein in general other release sensors 59 can also be provided which do not require mechanical release, so that a front gap between the movable furniture part 2 and the stationary furniture part 1 in the closed position for an overpressure movement for electronic releasing can be omitted, whereby a piece of furniture with a particularly aesthetically pleasing appearance can be achieved. A purely electronic releasing can be effected, for example, by contacting the movable furniture part 2, wherein, for example, a user pressing or wiping the movable furniture part on a furniture part front 23 is detected.

The distance measuring device 33 is arranged together with the electric drive device 6 in a stationary manner on the carcass rail 4, wherein a movement transmission of the electric drive energy to the rack 9 arranged on the drawer rail 5 takes place in order to be able to transmit force over the entire path 13 or starting from any point along the path 13 over a partial area of the path 13.

In the use position 14 of the arrangement, the position measuring device 33 is arranged completely below the movable furniture part 2 indirectly via the electric drive device 6 on the carcass rail 4. If necessary, a furniture part front 23 of the movable furniture part 2 can protrude below the electric drive device 6 or the position measuring device 33 in order, for example, to contact the release sensor 59. However, at least one floor of the movable furniture part 2 is arranged above the electric drive device 6.

Both gears 17 for position or speed determination have a microchip. Another gear 17 transfers the energy of the electric motor 7 to the rack 9.

The electric drive device 6 is arranged on the guiding mechanism 3 at least away from a closed position of the movable furniture part 2 without contact with the movable furniture part 2.

With reference to FIG. 10, an exemplary method for moving the movable furniture part 2 relative to the furniture part 1 at least partially along the path 13 of the movable furniture part 2 between a closed position and a partial or complete opening position 30 of the movable furniture part 2 by means of the electric drive device 6 and a path measuring device 33 is explained: Via the path measuring device 33, a position of the movable furniture part 2 relative to the stationary furniture part 1 is clearly determined as the absolute path traveled by the movable furniture part 2 relative to the stationary furniture part 1 and the movable furniture part 2 is moved translationally by the electric drive device 6 between the closed position and the opening position 30 along the guiding mechanism 3 over a partial region of the path 13 as a function of the absolute path determined by the path measuring device 33. A drive of the drawer rail 5 over the entire path 13 is generally possible due to the continuous coupling between the rack 9 and the electric drive device 6, but is not absolutely necessary.

In the method, the absolute path can be clearly determined starting from a predefined reference position, via a relative position of the position sensors 53, 54 and starting from a reference position via a sum or difference of rotation angles of the position sensors 53, 54 as a distance between the movable furniture part 2 (generally the drawer rail 5) and the stationary furniture part 1 (generally the carcass rail 4).

Via a control and/or regulating device 44 or a microcontroller 37, the movable furniture part 2 can be driven with a speed profile adapted to the determined speed or the determined absolute path, wherein the electric drive device 6 is activated at a predefined speed or at a predefined absolute path. Protection is also sought for a computer program product comprising commands which, when executed by a computer, cause the computer to carry out a method as described above from a memory which is in a data connection with the computer or which can be brought into such a connection with the same.

By means of the travel measuring device 33 and in particular by means of the clearly definable relative position between the stationary furniture part 1 or carcass rail 4 and the movable furniture part 2 or drawer rail 5, it can be ensured that even after a power failure or other malfunction, the position of the movable furniture part 2 along the travel path 13 of the guiding mechanism 3 can be clearly determined. The absolute distance traveled can be clearly calculated without reference travel, thus ensuring proper operation and, in particular, a drive that is adjusted to the position in a particularly fault-resistant manner.

In addition, the specific position can ensure proper detection of whether the movable furniture part 2 is to be subjected to force by the electric drive device 6 in the direction of the closed position or the open position 30. For example, based on the position and, if applicable, the speed, it can be determined whether the user of the movable furniture part 2 wants to move the movable furniture part 2 in a free-running area or wants a drive in the closing direction or opening direction. In addition, a speed profile to be transmitted to the movable furniture part 2 can be adjusted so that an individual speed can be individually transmitted for each position along the guiding mechanism. The position can provide additional information as to whether the movable furniture part 2 is to be freely movable in the free-running area (possibly bidirectionally) or driven via the electric drive device (in the closing direction or opening direction) as well as to what extent the force is to be applied or with which speed profile the movable furniture part 2 is to be moved.

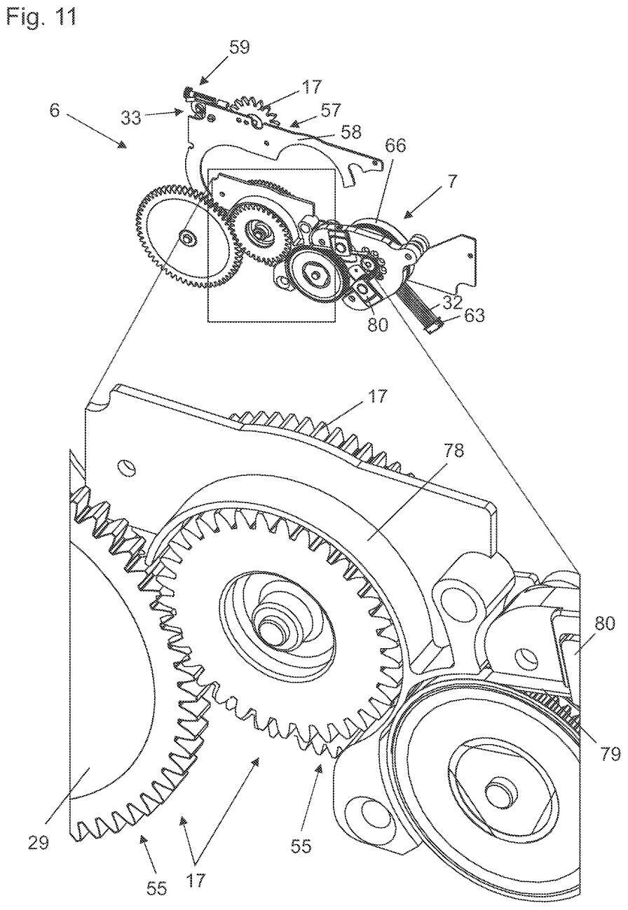

FIG. 11 and FIG. 12 show component parts of the electric drive device 6, wherein in FIG. 11, in the enlarged detail section, a protective carcass 78 integrated in the housing 47 can be seen, which protects the transmission—in particular a transmission stage 55—from abrasion by a belt (drive belt 79).

In FIG. 12, the belt drive in connection with the electric motor 7 is shown enlarged, wherein two belt tensioners 80 are provided, which provide a tension favorable for driving the electric drive device 6. In general, only one belt tensioner 80 or several belt tensioners 80 can be provided, wherein two belt tensioners 80 arranged on opposite sides of the drive belt 79 have proven to be particularly advantageous.

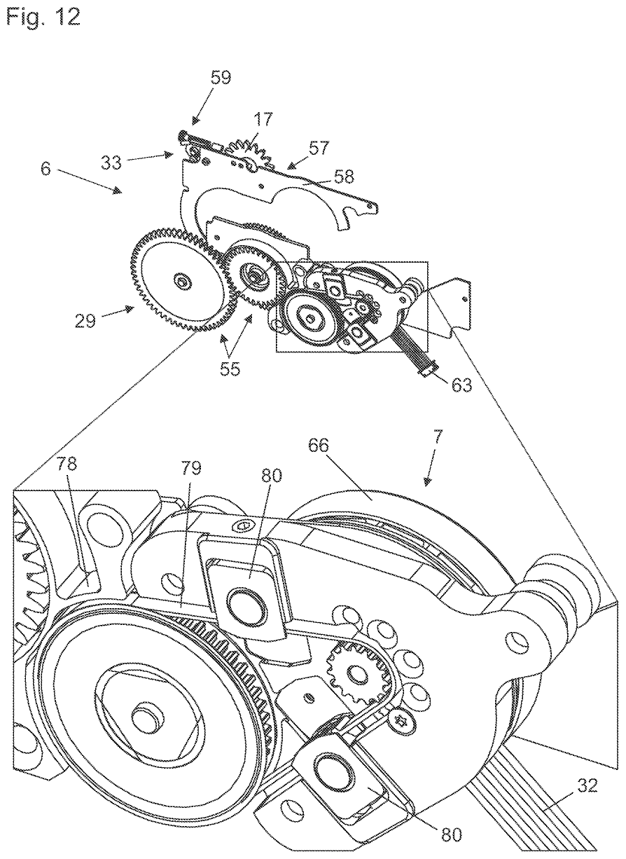

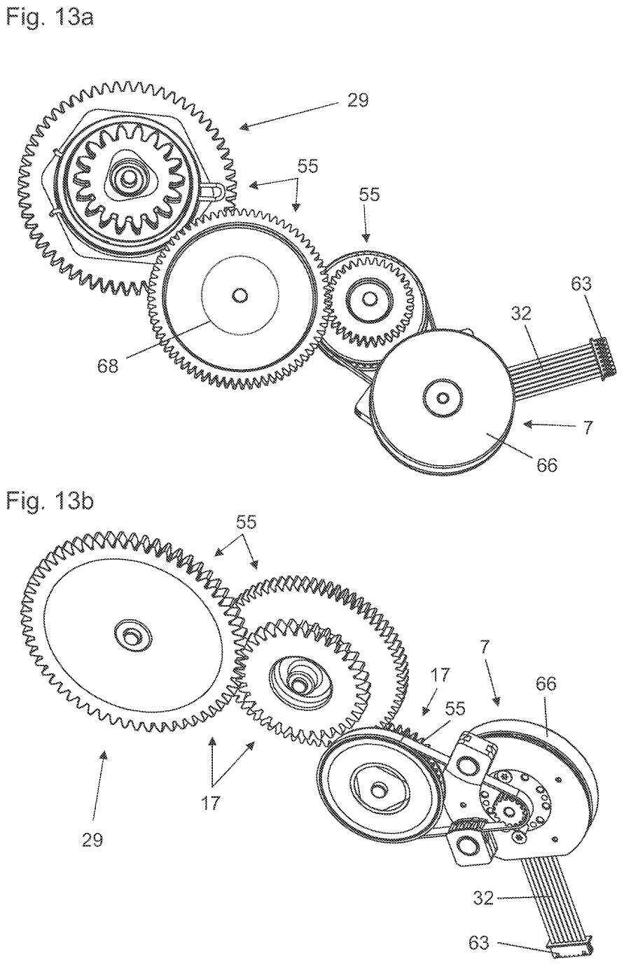

FIG. 13a shows the gear stages 55 of the electric motor 7, wherein the electric motor 7 is coupled to a freewheel clutch 29.

The electric motor 7 can generally comprise an overload clutch 68, which is only indicated schematically by a dotted line, since this is not necessarily required as a separate component.

FIG. 13b differs from FIG. 13a only in that it is viewed from a different angle.

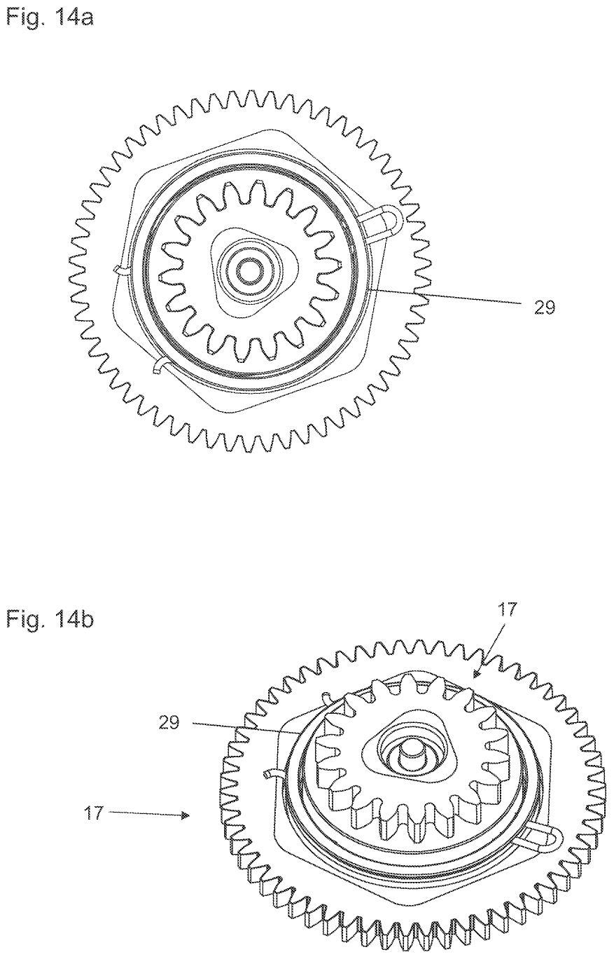

FIG. 14a and FIG. 14b show a one-way clutch 29 as a component comprising two gear wheels 17, which can act as gear stages 55. The overrunning clutch 29 is generally not self-locking.

Technical details of such a freewheel clutch 29—in particular a wrap spring freewheel clutch—can be found in EP 2 086 372 B2.

Since the freewheel clutch 29 is integrated in the electric drive device 6, the freewheel clutch 29 can remain stationary on the cabinet rail 4.

Specifically, the electric drive device 6 comprises the freewheel clutch 29, with which the movable furniture part 2 can be decoupled from a drive via the electric motor 7 in the closing direction and in the opening direction—for example depending on a speed of the movable furniture part 2 or a position of the movable furniture part 2—along the path 13. By means of the freewheel clutch 29, the movable furniture part 2 can be moved between an open position 30 and a closed position—for example depending on a force exerted on the movable furniture part 2—in a freewheeling area decoupled from a drive by the electric drive device 6 or can be driven over the path 13 (generally partial areas of the path 13) by the electric drive device 6.

An overload clutch 68 can generally also be provided, which—for example, depending on a speed of the movable furniture part 2 or a position of the movable furniture part 2—enables a decoupling between the electric motor 7 and the rack 9; by a double detachable connection of the rack 9 (detachable connection between support device 10 and rack 9 and closing device 8) during the engagement of the gear 17 of the electric drive device 6 in the function as an overload clutch 68, an integrated overload clutch 68 can be dispensed with. In general, it may be sufficient that only the rack 9 is detachably arranged on the support device 10 or only the support device 10 is detachably arranged on the closing device 8.

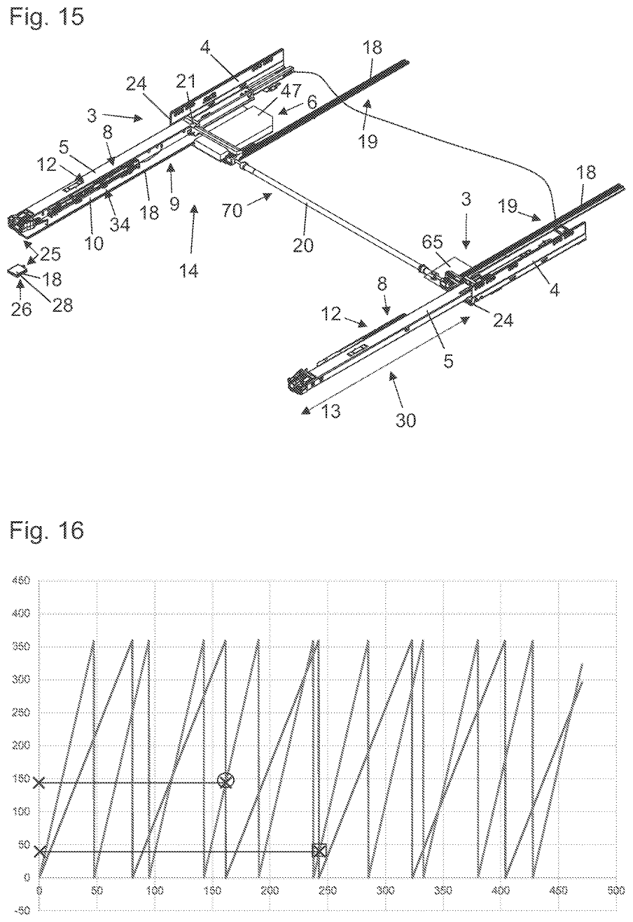

FIG. 15 shows an electric drive device 6 arranged on one side of the guiding mechanism 3, wherein a further release sensor 65 (schematically indicated by dotted lines) for activating the electric motor 7 for a closed position (activation in or via the closed position or, if applicable, an overpressure position) of a movable furniture part 2 arranged on the stationary furniture part 1 is arranged stationary on the second furniture panel 64 via the carcass rail 4 arranged on the second furniture panel 64.

The further release sensor 65 preferably comprises a damping device 12 or a buffer. The further release sensor 65 can be in data communication with the electric drive device 6 via a radio connection or a cable connection. The additional release sensor 65 eliminates the need to machine the furniture part front 23. Preferably, the additional release sensor 65 is used together with the release sensor 59.

The arrangement comprises a stabilization device 70 for lateral stabilization of the movable furniture part 2 along the guiding mechanism 3. In general, sufficient lateral stabilization can be generated via the movable furniture part 2 itself. It is conceivable to connect the stabilization device 70 to the second interface 35 (see FIG. 7a).

Two further racks 19 are arranged on the guiding mechanism 3, which are arranged on the two carcass rails 4, wherein a synchronization rod 20 is arranged between the two further racks 19 for lateral stabilization on the two further racks 19. The toothing 18 of the further racks 19 is oriented upwards in the vertical direction 15 and is orthogonal to an orientation of the toothing of the rack 9, although this is not absolutely necessary.

The synchronization rod 20 with the two further racks 19 can be provided as a separate configuration as an add-on, wherein at least one of the three component parts can be connected to the second interface 35, the rack 9, the carcass rail 4 or the electric drive device 6.

There is a direct power connection between the two carcass rails 4 (schematically shown by a dashed line). A power line 32 for the electric motor 7 can be routed via the carcass rail 4 or the rack 9—for example to supply energy to an ejection device 11.

On the left in the illustration it is schematically indicated that the rack 9 can comprise a coupling device 25 with which the rack 9 can be extended by a rack extension 26, wherein the rack 9 is then composed in the longitudinal direction 27 of at least two rack segments 28. This makes it possible to provide a length-adjustable rack 9 in order to be able to individually adjust the dimensions of the rack 9 to the dimensions of the guiding mechanism 3 or to an extension path along the path 13. In general, it is also conceivable to design the rack 9 to be telescopic.

FIG. 16 shows a diagram with sensor angles (in degrees) plotted on the ordinate and absolute distances along the path 13 (in mm) plotted on the abscissa. The position of the drawer rail 5 or the movable furniture part 2 can be clearly identified along the path 13 by the relative rotation position via the two position sensors 53, 54.

In the diagram, an intersection point of the sensor angles corresponding to an extension length of approximately 245 mm is marked with a square, whereby this intersection point corresponds to three complete rotations of the first position sensor 53 and five complete rotations of the second position sensor 54. The difference in the rotation angles corresponds to 36°, which clearly defines the position. A further intersection point of the sensor angles corresponding to an absolute travel of approximately 165 mm is marked with a circle, this intersection point corresponding to two complete revolutions of the first position sensor 53 and five complete revolutions of the second position sensor 54. The difference in the rotation angles corresponds to 144°, so that the position is defined uniquely.

In this exemplary embodiment, a signal tolerance of the first position sensor 53 based on a maximum number of six rotations for a clear position determination is equal to 60°. Analogously, a signal tolerance for the second position sensor 54 based on a maximum of 10 revolutions is equal to 36°. Combined, a tolerance can be reduced to +/−30° for the first position sensor 53 and +/−18° for the second position sensor 54, which is sufficiently accurate for a precise determination of the absolute travel via both position sensors 53, 54. For a given transmission ratio, a redundancy of intersection points for determining the absolute path may occur for long distances 13, wherein this undesirable situation can be eliminated by an entry in a memory unit or a varying transmission ratio. It is also conceivable to use additional sensors.

1. A computer-assisted method for moving a movable furniture part, in particular a drawer, relative to a stationary furniture part, in particular a furniture carcass, along a guiding mechanism, in particular a drawer pull-out guide, by at least one electric drive device, in particular one which can be supplied with 230 V, for automatically moving at least certain regions of the movable furniture part relative to the stationary furniture part via an electric motor, comprising the following steps preferably carried out in chronological order:
determining a model of the movable furniture part depending on at least one static dataset stored in a memory unit using a microcontroller comprising a computer and the memory unit that either is or can be connected to the computer in a data-transmitting manner,
manually moving the movable furniture part either from an open position or a position between the open position and a closed position towards the closed position, and/or vice versa, and
calculating a predicted movement trajectory of the movable furniture part along the guiding mechanism depending on at least one dynamic dataset using the microcontroller.

2. The method according to claim 1, wherein:
selecting the at least one static dataset from the following parameters: mass of the movable furniture part, friction of the movable furniture part on the guiding mechanism, dimensioning of the movable furniture part, load in the movable furniture part, dimensioning of the guiding mechanism, distance traveled along the guiding mechanism, tolerance limits or the like, and/or
selecting the at least one dynamic dataset from the following parameters: absolute distance traveled by the movable furniture part relative to the stationary furniture part, speed of the movable furniture part, load in the movable furniture part, acceleration profile of the movable furniture part, acceleration distance of the movable furniture part, kinetic energy of the movable furniture part or the like,
wherein it is preferably provided that the at least one static dataset and/or the at least one dynamic dataset is determined in at least one reference travel of the movable furniture part, particularly preferably a plurality of reference travels with varying loads of the movable furniture part.

3. The method according to claim 1, wherein the microcontroller makes a decision as a function of the predicted movement trajectory as to whether the at least one electric drive device should apply force to the movable furniture part, preferably in the direction of the closed position or the open position, or whether the movable furniture part should be manually movable in a freewheeling region, wherein it is preferably provided that the electric motor comprises a freewheel clutch with which a force transmission from the electric motor to the movable furniture part is separated in the freewheeling region.

4. The method according to claim 1, wherein the microcontroller calculates, depending on the at least one static dataset and the at least one dynamic dataset, whether the movable furniture part reaches the closed position without application of force via the electric drive device, wherein a speed of the movable furniture part when entering the closed position is determined particularly preferably as a function of a damping power of a damping device arranged on the movable furniture part or the stationary furniture part.

5. The method according to claim 1, wherein the microcontroller defines a speed profile for the drive of the movable furniture part transmitted via the at least one electric drive device as a function of the predicted movement trajectory, wherein the at least one electric drive device applies force to the movable furniture part as a function of the speed profile, wherein:
the speed profile is created as a function of the at least one static dataset and/or the at least one dynamic dataset, and/or
the movable furniture part is subjected to energy at a speed of the movable furniture part below the speed profile, and/or
at a speed of the movable furniture part above the speed profile, it is braked by the at least one electric drive device, and/or
at a predefined speed threshold and/or a predefined position threshold, a force transmission to the movable furniture part is initiated.

6. The method according to claim 1, wherein the microcontroller is stored with at least one learning algorithm, preferably machine learning, deep learning, neural network and/or artificial intelligence, with which the predicted movement trajectories of a history are analyzed and/or compared with one another, wherein it is preferably provided that the history of predicted movement trajectories, particularly preferably depending on the respective static datasets and/or dynamic datasets, are used for movement trajectories to be predicted in the future and/or future speed profiles and/or future decisions regarding the application of force to the movable furniture part.

7. The method according to claim 1, wherein the guiding mechanism comprises:
two carcass rails which can be arranged or are arranged on the stationary furniture part, wherein the at least one electric drive device remains stationary on at least one of the two carcass rails during a movement of the movable furniture part, and/or
two drawer rails, wherein at least one of the two drawer rails comprises a toothed rack for transmitting movement from a gear wheel of the at least one electric drive device to the drawer rail, wherein the at least one electric drive device remains arranged on the drawer rail for driving during a movement of the movable furniture part.

8. The method according to claim 1, wherein the movable furniture part is driven by the at least one electric drive device starting from the open position or a position between the open position and the closed position over an entire path up to the closed position and/or open position or only over a partial region of the path, wherein it is preferably provided that a force application by the at least one electric drive device starting from the closed position in the direction of the open position is initiated by an over-pressing movement of the movable furniture part and/or the movable furniture part is manually movable in a non-driven partial region of the path in a free-running region.

9. The method according to claim 1, wherein:
at least one path measuring device is provided for determining a position of the movable furniture part relative to the stationary furniture part, wherein the position is determined in the form of an absolute path travelled by the movable furniture part relative to the stationary furniture part as a dynamic dataset by the at least one path measuring device, preferably unambiguously, and/or
at least one speed measuring device is provided for determining a speed of the movable furniture part relative to the stationary furniture part, wherein the speed is determined as a dynamic dataset by the at least one speed measuring device.

10. The method according to claim 1, wherein the movable furniture part is subjected to force by the at least one electric drive device in the direction of the open position over a partial region of the travel distance in the range between 50 mm and 150 mm and/or in the direction of the closed position over a partial region of the travel distance in the region between 5 mm and 20 mm.

11. The method according to claim 1, wherein a movement of the movable furniture part in the direction of the closed position and/or the open position is damped, braked or blocked via the at least one electric drive device, wherein it is preferably provided that the movable furniture part is subjected to force in the direction of the closed position by a closing device in the region of the closed position.

12. A microcontroller configured to perform the method according to claim 1, comprising a computer and a memory unit which is or can be brought into data connection with the computer, characterized in that the computer is configured to determine a model of a movable furniture part as a function of at least one static data set stored in the memory unit and/or to calculate a predicted movement trajectory of the movable furniture part along a guiding mechanism as a function of a dynamic data set stored in the memory unit.

13. An electric drive device for automatically moving at least certain regions of a movable furniture part relative to a stationary furniture part via an electric motor with the microcontroller according to claim 12.

14. The electric drive device according to claim 13, wherein at least one, in particular stationary, lighting means is arranged on the at least one electric drive device and/or on a power line of the at least one electric drive device.

15. The electric drive device according to claim 13, comprising:
at least one stop, which can preferably be adjusted via at least one adjusting device and/or initiated via an overpressure movement, for activating the electric motor, preferably via a microswitch, and/or
a data interface for the wired and/or radio signal transmission of at least one digital dataset stored in a storage unit.

16. The electric drive device according to claim 13, wherein at least one release sensor is provided for activating the electric motor for a closed position of a movable furniture part, wherein the electric drive device has a housing and the at least one release sensor is arranged on the housing for contacting a movable furniture part in the use position of the electric drive device, wherein it is preferably provided that the at least one release sensor comprises a plunger and/or a microswitch and/or can be released tactilely and/or electronically.

17. An arrangement comprising the electric drive device according to claim 13, and a stationary furniture part, in particular a furniture carcass, the stationary furniture part comprising two furniture panels oriented vertically and parallel to one another in the position of use of the arrangement, wherein exactly one electric drive device is arranged stationarily on one of the two furniture panels, preferably indirectly via a body rail of a guiding mechanism, wherein at least one further release sensor for activating the electric motor for a closed position of a movable furniture part arranged on the stationary furniture part is arranged stationarily on the second furniture panel, preferably on a carcass rail arranged on the second furniture panel, wherein it is preferably provided that the at least one further release sensor comprises a damping device and/or a buffer and/or is or can be brought into data connection with the electric drive device via a radio connection and/or a cable connection.

18. The arrangement according to claim 17, further comprising a guiding mechanism with at least one carcass rail arranged on the stationary furniture part and at least one drawer rail arranged on the movable furniture part, wherein the at least one drawer rail comprises at least one first interface which is suitable for fixing an ejection device and/or a closing device to the at least one drawer rail, and the at least one carcass rail comprises at least one second interface which is suitable for fixing a driver for the ejection device and/or the closing device to the at least one carcass rail, wherein the electric drive device is arranged or can be arranged at the at least one second interface and at least one toothed rack for transmitting power from the electric drive device on the at least one drawer rail is arranged or can be arranged on the at least first interface.

19. The arrangement according to claim 17, wherein the electric drive device in the use position of the arrangement is arranged substantially completely below the movable furniture part on a carcass rail.

20. The arrangement according to claim 17, further comprising a guiding mechanism with at least one drawer rail, wherein at least one closing device for the movable furniture part and at least one toothed rack operatively connected to the electric drive device are provided, wherein the at least one closing device is arranged, preferably directly, on the at least one drawer rail and the at least one toothed rack is arranged, preferably indirectly, on the at least one drawer rail, wherein the at least one toothed rack is detachably arranged on at least one support device and the at least one support device is detachably arranged on the at least one closing device.

21. A computer program product, comprising commands which, when executed by a computer, cause the latter to perform the method according to claim 11 from a memory unit which is in a data connection with the computer or can be brought into such a connection with the same.
